(19) United States
(12) Patent Application Publication
(10) Pub. No.: US 2024/0392078 A1
(43) Pub. Date: Nov. 28, 2024

(54) PROCESS FOR MANUFACTURING FIBER-REINFORCED ADDITIVELY MANUFACTURED COMPOSITES

(71) Applicant: UT-Battelle, LLC, Oak Ridge, TN (US)

(72) Inventors: James W. Klett, Oak Ridge, TN (US); Edgar Lara-Curzio, Oak Ridge, TN (US); Kashif Nawaz, Oak Ridge, TN (US); Bola Yoon, Oak Ridge, TN (US)

(21) Appl. No.: 18/409,522

(22) Filed: Jan. 10, 2024

Related U.S. Application Data
(60) Provisional application No. 63/438,272, filed on Jan. 11, 2023.

(51) Int. Cl. C08J 5/00; B29C 64/10; B29C 64/209; B29K 71/00; C08J 5/04; C08J 5/10; C08K 5/315; C08K 7/02

(52) U.S. Cl. CPC C08J 5/005; B29C 64/10; B29C 64/209; C08J 5/046; C08J 5/10; C08K 5/315; B29K 2071/00; C08J 2371/10; C08K 7/02; C08K 2201/003; C08K 2201/004

(57) ABSTRACT

A method for manufacturing a fiber-reinforced ceramic matrix composite article is provided. The method includes additively manufacturing a carbon fiber-reinforced thermoplastic article via fused filament fabrication (FFF). The article is then thermally annealed to yield an non-meltable article. The method further includes pyrolyzing the non-meltable article to yield a pyrolyzed article. The pyrolyzed article is infiltrated with an infiltration agent to yield a fiber-reinforced infiltrated matrix composite.

### CROSS-REFERENCE TO RELATED APPLICATIONS

This application claims the benefit of U.S. Provisional Application 63/438,272, filed Jan. 11, 2023, the disclosure of which is hereby incorporated by reference.

### STATEMENT REGARDING FEDERALLY SPONSORED RESEARCH AND DEVELOPMENT

This invention was made with government support under Contract No. DE-AC05-00OR22725 awarded by the U.S. Department of Energy. The government has certain rights in the invention.

### FIELD OF THE INVENTION

The present invention relates to the manufacture of fiber reinforced polymer-ceramic composites.

### BACKGROUND OF THE INVENTION

The addition of dispersed reinforcing phases has been demonstrated to be one of the most effective methods for overcoming the brittle behavior of ceramics. Among the various reinforcing phases, those with a large geometrical aspect ratio, such as a high-strength fibers, have been found to provide significant toughening through energy absorbing and dissipating mechanisms, including the deflection of cracks at the fiber-matrix interface, and fiber debonding and sliding to bridge matrix cracks.

Carbon and silicon carbide fibers are widely used for reinforcing ceramic materials, including silicon carbide, because of their high strength, high elastic modulus, and high stability at elevated temperatures. Silicon carbide is a leading candidate for manufacturing ceramic matrix composites because of its unique physical properties, including its low coefficient of thermal expansion, high thermal conductivity, low density, and resistance to wear and extreme environments.

Developments in additive manufacturing have enabled the fabrication of ceramic objects, including silicon carbide, with complex internal structures and shapes that could not be manufactured using conventional manufacturing methods. Carbon fiber reinforced silicon carbide composites have been fabricated through the production of green bodies by selective laser sintering (SLS) using composite feedstock particles containing phenolic resin, chopped carbon fibers and silicon powders. The printed bodies are post-processed through phenolic infiltration and pyrolysis, and a final reactive silicon infiltration step.

The Fused Filament Fabrication (FFF) method, along with the availability of fiber-reinforced polymeric filaments, provides another method for manufacturing fiber-reinforced carbon and siliconized silicon carbide matrix composites with complex internal structures and shapes. An object with arbitrary geometry can be manufactured via FFF using a carbon fiber-reinforced thermoplastic filament. Following manufacture, the 3D printed object is pyrolyzed to obtain a fiber-reinforced porous carbon matrix composite and the carbon matrix is infiltrated with a polymeric precursor for carbon (e.g., phenolic resin) or for silicon carbide (e.g., polycarbosilane resin) to increase the density of the matrix. Infiltration can also be performed using molten silicon, which yields a dense composite by forming silicon carbide from the reaction of silicon with carbon, as well as unreacted residual silicon.

### SUMMARY OF THE INVENTION

A method for manufacturing a fiber-reinforced ceramic matrix composite article is provided. The method includes additively manufacturing a carbon fiber-reinforced thermoplastic article via fused filament fabrication (FFF). The article is then thermally annealed to yield a non-meltable article. The method further includes pyrolyzing the non-meltable article to yield a pyrolyzed article. The pyrolyzed article is infiltrated with an infiltration agent to yield a fiber-reinforced infiltrated matrix composite. The infiltration agent may be silicon, phenolic resin, or polycarbosilane.

In one embodiment, the method includes additively manufacturing an article via fused filament fabrication. This step includes feeding a polyetheretherketone (PEEK) filament through a heated nozzle, which melts the filament into a semi-liquid state, which is then deposited layer by layer to create a three-dimensional object. As each layer is deposited, it quickly cools and solidifies, bonding to the previous layer(s). The PEEK filament optionally comprises between 10% and 30% by volume of chopped polyacrylonitrile (PAN)-based carbon fibers with a diameter of between 5 μm and 10 μm. The three-dimensional object is then thermally annealed in air at a temperature below the melting point of the PEEK filament. This annealing step suppresses melting and promotes shape retention during the subsequent pyrolysis step. For example, because the PEEK filament has a melting temperature of about 343° C. at atmospheric pressure, the annealing temperature can be between 300 to 320° C. Pyrolyzing the non-meltable article comprises heating the non-meltable article to a temperature of between 800 to 900° C. The method optionally includes infiltrating the pyrolyzed article with the infiltration agent via reactive melt infiltration.

These and other features and advantages of the present invention will become apparent from the following description of the invention, when viewed in accordance with the accompanying drawings and appended claims.

### BRIEF DESCRIPTION OF THE DRAWINGS

FIG. 1 includes photographs of carbon fiber-reinforced PEEK preforms after thermal annealing for 48 hours in air at different temperatures.

FIG. 2 is a schematic diagram of a melting-recrystallization-annealing process of a carbon fiber-reinforced PEEK preform.

### DETAILED DESCRIPTION OF THE CURRENT EMBODIMENTS

A method for manufacturing a fiber-reinforced infiltrated matrix composite article is provided. The method includes additively manufacturing a carbon fiber-reinforced thermoplastic article via fused filament fabrication (FFF). The carbon fiber-reinforced thermoplastic article is thermally annealed in air to give a non-meltable article, which is then pyrolyzed. The pyrolyzed article is infiltrated with the infiltration agent, resulting in a carbon fiber-reinforced infiltrated matrix composite article. Each step is separately discussed below.

The fiber-reinforced thermoplastic article is additively manufactured via fused filament fabrication. Fused filament fabrication (FFF) includes several substeps. First, a digital model of the article is converted into an additive manufacturing format for producing parts. Next, the digital model is sliced into multiple layers. During printing, a three-dimensional model is built by depositing layer upon layer. In some embodiments, the G-code for each layer is used to control the movement of an FFF extruder in the XY plane of an FFF machine. Generally, the FFF machine will have software for slicing and generating G-code. In these embodiments, the STL file is directly uploaded to the FFF machine software. Then, in the machine setup step, the values of different FFF process parameters, such as print speed, build orientation, and infill density, are defined. During printing, an extruder of the FFF machine moves in a horizontal direction according to a pre-generated tool path for deposing a layer. Once a layer is deposited, the build platform moves downward in a z-direction. The next layer is deposited over the preceding layer and repeats until the fabrication of the article is completed. The strength of the built part depends on the bonding between two consecutive layers. Sufficient heat energy is required to activate the surface of the former deposited layer and cause adhesion between the activated surface and the newly deposited layer.

In some embodiments, the FFF machine is a closed chamber FFF printer. The FFF machine comprises a nozzle and a bed. The FFF machine optionally has a nozzle diameter of 0.5 to 1.2 mm, alternatively 0.7 to 0.9 mm. The FFF machine optionally prints a layer height of 0.2 to 0.6 mm, alternatively 0.3 to 0.4 mm. The FFF machine optionally prints at a printing speed of 20 to 50 mm/s, alternatively 30 to 40 mm/s. The FFF machine optionally prints at a nozzle temperature of 300 to 500° C., alternatively 350 to 450° C. The FFF machine optionally prints with a bed temperature of 100 to 200° C., alternatively 140 to 180° C., with a raster angle of 0° to 90°.

The resulting fiber-reinforced thermoplastic article comprises a thermoplastic and carbon fibers. The carbon fiber-reinforced thermoplastic article is additively manufactured using an article feedstock. The feedstock may comprise 1.75 mm diameter PEEK filament containing 20% chopped polyacrylonitrile (PAN)-based carbon fibers. The carbon fibers may have a diameter between 5 and 10 um and an average length of 100 μm.

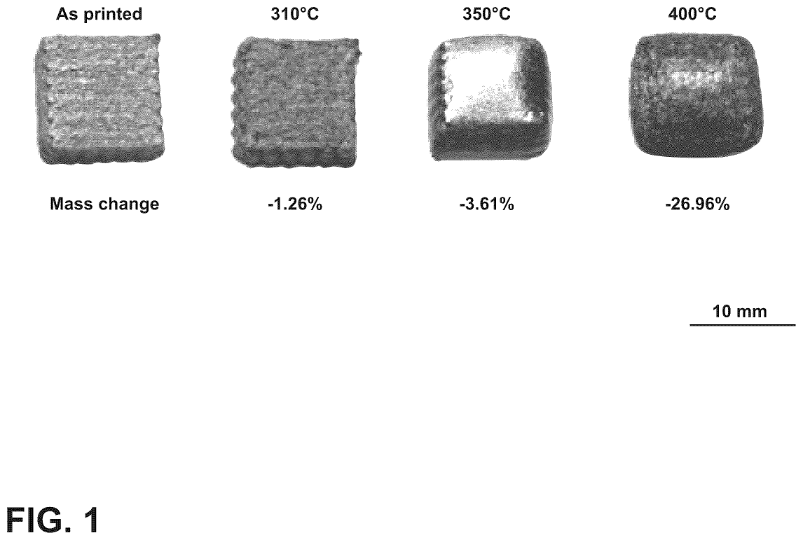

The fiber-reinforced thermoplastic article is thermally annealed to give a non-meltable article. The fiber-reinforced thermoplastic article is thermally annealed at an annealing temperature for an annealing time. The annealing temperature is between 280 to 420° C., alternatively 300 to 400° C., alternatively 300 to 320° C. The annealing time is between 24 and 72hours, alternatively 36 and 60 hours. As shown in FIG. 1, annealing temperatures above 310° C. cause geometrical distortion and decrease the mass of the article. An article annealed at 310° C. preserved a shape similar to that of the article as printed. However, its surface became slightly duller and the mass change was only a 1.26% reduction. An article annealed at 350° C. exhibited swelling relative to the article as printed, had a shiny surface, and experienced a more substantial mass change of 3.61%. An article annealed at 400° C. was severely distorted, had a dull surface and experienced a significant mass change of about 30%.

Without being bound by any specific theory, it is believed that in embodiments where the thermoplastic is PEEK that the annealing causes random chain scissions in the PEEK of ether and ketone bonds that create stable intermediate radicals as well as opening aromatic rings and hydrogenating aromatic groups. These reactions reduce the number of carbonyl groups of saturated aliphatic aldehydes. The stable intermediate radicals then react with each other to crosslink the PEEK. Therefore, in this way, the annealing process promotes crosslinking of PEEK.

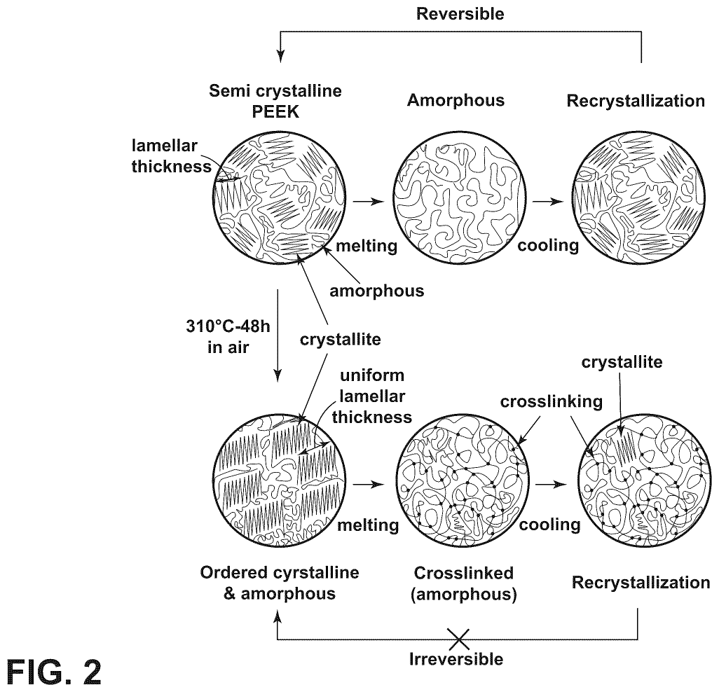

As shown in FIG. 2, the annealing step has a substantial impact on the microstructure of the article. Melting a PEEK article will destroy the existing crystalline structure of the PEEK article and create an amorphous microstructure. If the melted PEEK article is cooled it will recrystallize. Therefore, melting/cooling of a PEEK article is essentially reversible. In contrast, annealing of a PEEK article is irreversible. Thermal annealing of the PEEK article promotes the reorganization and growth of PEEK crystal lamellar within the microstructure and crosslinking, which involves the formation of covalent bonds between polymer chains, that increases molecular weight, restricts molecular movement, and thereby increases the melting temperature of the PEEK article. The non-meltable article exhibits rubbery behavior and has a microstructure with more distinct amorphous character, even after cooling, because of the crosslinking of the polymer.

The non-meltable article is then pyrolyzed to give a pyrolyzed article. Pyrolysis includes heating the non-meltable article above a threshold temperature for pyrolysis (“the threshold temperature”) to a pyrolysis temperature. Generally, the threshold temperature is a temperature greater than 550° C., alternatively greater than 580° C., and the pyrolysis temperature is between 800 to 900° C., alternatively between 825 to 975° C. The non-meltable article is heated to the pyrolysis temperature at a heating rate. The heating rate may be at the rate of 1° C./min. The non-meltable article is held at the pyrolysis temperature for a pyrolysis time. The pyrolysis time is 10 to 90 minutes, alternatively 15 to 45 minutes.

As the non-meltable article is heated to the threshold temperature, the non-meltable article may undergo thermal volumetric expansion. Thermal volumetric expansion of the non-meltable article may continue up to temperatures around ˜450° C. However, above and around the threshold temperature the article may undergo volumetric shrinkage. The volumetric shrinkage of the article is not generally identical in every direction, and the volumetric shrinkage in any given direction will vary depending on a build direction of the non-meltable article. More specifically, the build direction, and by extension the volumetric shrinkage in a given direction, will be impacted by the orientation of the carbon fibers within the non-meltable article.

During pyrolysis, the PEEK or other material will undergo chain scissions and crosslinking. The chain scissions and crosslinking compete to influence the molecular weight of the PEEK or other material, with the chain scissions reducing the molecular weight and the crosslinking increasing the molecular weight. The chain scission leads to the generation of volatile species. In embodiments where the material is PEEK, the volatile species will include phenols, CO, and CO₂. The crosslinking will lead to char formation. Therefore, increased char yield on the article indicates a higher density of crosslinking after thermal annealing.

The microstructure of the pyrolyzed article may comprise carbon fibers embedded in carbon sheaths that contain cracks and form, nucleate, and grow during pyrolysis due to the mass loss and constrained shrinkage of the material during pyrolysis and cooling. In some embodiments, the carbon fibers constrain the flow of any polymer melted during the pyrolysis treatment.

The pyrolyzed article is infiltrated with the infiltration agent to give the fiber-reinforced infiltrated matrix composite article. The infiltration agent may comprise, alternatively may be, one of silicon, phenolic resin, or polycarbosilane. Infiltration of the pyrolyzed article occurs at an infiltration temperature for an infiltration time. The infiltration temperature is from 1410 to 1600° C. The infiltration time is 10 to 90 minutes, alternatively 15 to 45 minutes. Infiltration of the pyrolyzed article occurs in a vacuum (i.e., pressure below 0.1 Pa). The step of infiltrating the pyrolyzed article with the infiltration agent may include reactive melt infiltration of the pyrolyzed article with the infiltration agent. Reactive melt infiltration of the pyrolyzed article with the infiltration agent may include filling the cracks in the carbon matrix that formed during pyrolysis of the pyrolyzed article with molten infiltration agent. In embodiments where the infiltration agent is silicon, the molten silicon reacts with the carbon matrix to form silicon carbide. In embodiments where the infiltration agent is phenolic resin, the molten phenolic resin is converted into carbon during pyrolysis to form a carbon-carbon composite. Several infiltration and/or pyrolysis steps may be necessary to maximize densification. In embodiments where the infiltration agent is polycarbosilane resin, the molten polycarbosilane resin reacts with silicon to be converted into silicon carbide during pyrolysis to form a carbon-silicon carbide matrix composite. Several infiltration and/or pyrolysis steps may be necessary to maximize densification.

In some embodiments, the step of infiltrating the pyrolyzed article is followed by a further post-infiltration heating step where the carbon fiber-reinforced infiltrated matrix composite article is heated to a post-infiltration heating temperature in argon for a post-infiltration heating time. The post-infiltration heating temperature is a temperature of from 1600 to 1750° C., alternatively from 1650 to 1700° C. The post-infiltration heating time is from 2 to 6 hours, alternatively from 3 to 5 hours. Generally, the post-infiltration heating step improves the densification of the matrix by allowing the molten infiltration agent to further fill pores of the article.

Direct chemical reactions between the molten infiltration agent and the carbon fibers may damage the carbon fiber. This damage to the carbon fiber may compromise the structural integrity of the fibers and adversely impact the strength and toughness of the article. To counteract the harmful reaction between the carbon fibers and the molten infiltration agent, the carbon fibers are coated with a fiber-matrix interphase. The fiber-matrix interphase prevents interaction between the carbon fibers and molten infiltration agent and ensures the tough mechanical properties of the fiber-reinforced ceramic matrix composites. The article may be subjected to multiple cycles of infiltration and pyrolysis using polymeric precursors for carbon or silicon carbide, or by reactive melt infiltration with the infiltration agent, to increase the matrix density of the article.

The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular.

1. A method for manufacturing a fiber-reinforced infiltrated matrix composite article, the method comprising the steps of:
additively manufacturing a fiber-reinforced thermoplastic article via fused filament fabrication (FFF);
thermally annealing the fiber-reinforced thermoplastic article to give an non-meltable article;
pyrolyzing the non-meltable article to give a pyrolyzed article; and
infiltrating the pyrolyzed article with an infiltration agent to produce a fiber-reinforced infiltrated matrix article.

2. The method of claim 1, wherein the fiber-reinforced thermoplastic article comprises polyetheretherketone (PEEK).

3. The method of claim 2, wherein the fiber-reinforced thermoplastic article is additively manufactured using an article feedstock comprising PEEK filaments containing at least 20% by volume of chopped polyacrylonitrile (PAN)-based carbon fibers.

4. The method of claim 3, where the carbon fibers have a diameter between 5 and 10 μm and an average length of 100 μm.

5. The method of claim 1, wherein the fiber-reinforced thermoplastic article is additively manufactured by a FFF machine comprising a nozzle and bed, and the FFF machine (i) has a nozzle diameter of 0.5 to 1.2 mm; (ii) prints a layer height of 0.2 to 0.6 mm; (iii) prints at a printing speed of 20 to 50 mm/s; (iv) prints at a nozzle temperature of 300 to 500° C.; (v) prints at a bed temperature of 100 to 200° C.; (vi) has a raster angle of 0° to 90°; or (vii) a combination of any of (i)-(vi).

6. The method of claim 1, wherein the fiber-reinforced thermoplastic article is thermally annealed at an annealing temperature between 280 to 420° C.

7. The method of claim 6, wherein the fiber-reinforced thermoplastic article is thermally annealed at an annealing temperature between 300 to 320° C.

8. The method of claim 1, wherein the carbon fiber-reinforced thermoplastic article is thermally annealed for an annealing time between 24 to 72 hours.

9. The method of claim 1, wherein the carbon fiber-reinforced thermoplastic article is thermally annealed for an annealing time between 36 to 60 hours.

10. The method of claim 1, wherein pyrolyzing the non-meltable article comprises heating the non-meltable article to a pyrolysis temperature of between 800 to 900° C.

11. The method of claim 10, wherein the non-meltable article is heated at a rate of 1° C./min.

12. The method of claim 10, wherein the non-meltable article is held at the pyrolysis temperature at a pyrolysis time of from 10 to 90 minutes.

13. The method of claim 1, wherein the step of infiltrating the pyrolyzed article with the infiltration agent comprises reactive melt infiltration of the pyrolyzed article with silicon.

14. The method of claim 1, wherein infiltration of the pyrolyzed article occurs at an infiltration temperature from 1410 to 1600° C.

15. The method of claim 1, wherein infiltration of the pyrolyzed article occurs for an infiltration time of 10 to 90 minutes.

16. The method of claim 1, wherein infiltration of the pyrolyzed article occurs at a pressure below 0.1 Pa.

17. The method of claim 1, wherein the method further comprises heating the fiber-reinforced infiltrated matrix composite article to a post-infiltration heating temperature in argon for a post-infiltration heating time.

18. The method of claim 17, wherein the post-infiltration heating temperature is from 1600 to 1750° C.

19. The method of claim 17, wherein the post-infiltration heating time is from 2 to 6 hours.

20. The method of claim 1, wherein the method further comprises repeating one of the steps of pyrolyzing the non-meltable article; or
infiltrating the pyrolyzed article with the infiltration agent.
